(19) United States
(12) Patent Application Publication
(10) Pub. No.: US 2016/0373021 A1
(43) Pub. Date: Dec. 22, 2016

(54) CONVERTER WITH A POWER FACTOR CORRECTION CIRCUIT

(71) Applicant: STMicroelectronics (Tours) SAS, Tours (FR)

(72) Inventor: Laurent Gonthier, Tours (FR)

(73) Assignee: STMicroelectronics (Tours) SAS, Tours (FR)

(21) Appl. No.: 14/964,618

(22) Filed: Dec. 10, 2015

(30) Foreign Application Priority Data
Jun. 22, 2015 (FR) 1555691

(51) Int. Cl. H02M 7/06; H02M 1/42; H02M 7/217

(52) U.S. Cl. CPC H02M 7/06; H02M 7/217; H02M 1/4208

(57) ABSTRACT

An AC/DC converter includes a first terminal and a second terminal for receiving an AC voltage and a third terminal and a fourth terminal for delivering a DC voltage. Two transistor switches are series-connected between the third and fourth terminals, with their junction point connected to the first terminal. Two controllable rectifying elements are series-connected between the third and fourth terminals, with their junction point connected to the first terminal or to the second terminal. The two controllable rectifying elements are phase-angle controlled.

### PRIORITY CLAIM

This application claims the priority benefit of French Application for Patent No. 1555691, filed on Jun. 22, 2015, incorporated by reference in its entirety to the maximum extent allowable by law.

### TECHNICAL FIELD

The present disclosure generally relates to electronic devices and, more specifically, to AC/DC converters. The present disclosure more specifically relates to a converter having a function of power factor correction (PFC) and generally applies to any system using such a converter, for example, circuits for controlling electric motors, electric chargers, switched-mode power supplies, etc.

### BACKGROUND

Many AC/DC converter architectures based on rectifying elements, which may be controllable (thyristors, for example) or not (diodes, for example), assembled as a rectifying bridge, powered with an AC voltage and delivering a DC voltage, this DC voltage being possibly itself converted back into an AC voltage, are known.

Among such architectures, a solution using a complete inverter branch and another arm with diodes (generally called “totem pole”) is a bridge-less architecture based on two switches controlled in pulse width modulation.

Document EP-A-2515420 (United States Publication 2012/0268084, incorporated by reference) describes an example of power factor correction converter of “totem pole” type.

The inrush current, that is, the current peaks which occur on each halfwave of the AC voltage as long as the voltage across an output capacitor has not reached a sufficient level and, this, particularly, in starting phases, is generally desired to be limited.

### SUMMARY

An embodiment overcomes all or part of the disadvantages of usual power converter control circuits.

An embodiment provides a power factor correction power converter of “totem pole” type.

Thus, an embodiment provides an AC/DC converter comprising: a first terminal and a second terminal, intended to receive an AC voltage; a third terminal and a fourth terminal, intended to supply a DC voltage; two switches series-connected between the third and fourth terminals, having their junction point connected to the first terminal; and two controllable rectifying elements series-connected between the third and fourth terminals, having their junction point connected to the first terminal or to the second terminal.

According to an embodiment, two diodes are respectively connected in parallel with each of the two switches.

According to an embodiment, said two diodes are formed by the intrinsic diodes of the switches.

According to an embodiment, the rectifying elements are phase-angle controlled.

According to an embodiment, the two rectifying elements respectively are cathode-gate and anode-gate thyristors, the anode-gate thyristor being controllable by extraction of a current from its gate.

According to an embodiment, the anode-gate thyristor is connected to the third terminal.

According to an embodiment, the thyristors are controlled by a same pulse signal.

According to an embodiment, the anode-gate thyristor is connected to the fourth terminal, the cathode-gate thyristor being connected to the third terminal and being controllable by injection and/or extraction of a gate current.

According to an embodiment, the rectifying elements are anode-gate thyristors, controllable by extraction of a current from their gate.

An embodiment provides a converter, further comprising: a circuit for powering a control circuit of at least the controllable rectifying elements; and at least one diode coupling one of the first and second terminals to said power supply circuit.

### BRIEF DESCRIPTION OF THE DRAWINGS

The foregoing and other features and advantages will be discussed in detail in the following non-limiting description of specific embodiments in connection with the accompanying drawings, wherein:

FIG. 1 schematically shows an example of a usual architecture of a so-called “totem pole” AC/DC power factor correction converter;

FIG. 2 schematically shows an embodiment of a “totem pole” AC/DC converter;

FIG. 3 is a partial electric diagram of an embodiment of a control circuit of controllable rectifying elements of the converter of FIG. 2;

FIG. 4 schematically and partially shows another embodiment of a “totem pole” AC/DC converter;

FIG. 5 schematically and partially shows still another embodiment of a “totem pole” AC/DC converter;

FIG. 6 schematically and partially shows still another embodiment;

FIG. 7 is a simplified cross-section view of an embodiment of a cathode-gate thyristor having a positive gate current; and

FIG. 8 is a simplified cross-section view of an embodiment of a cathode-gate thyristor having a negative gate current.

### DETAILED DESCRIPTION

The same elements have been designated with the same reference numerals in the different drawings. In particular, the structural and/or functional elements common to the different embodiments may be designated with the same reference numerals and may have identical structural, dimensional, and material properties. For clarity, only those steps and elements which are useful to the understanding of the described embodiments have been shown and will be detailed. In particular, the circuits powered by the power converter have not been detailed, the described embodiments being compatible with usual applications. In the disclosure, term “connected” designates a direct connection between two elements, while terms “coupled” and “linked” designate a connection between two elements which may be direct or via one or a plurality of other elements. When reference is made to terms “about”, “approximately”, or “in the order of”, this means to within 10%, preferably to within 5%.

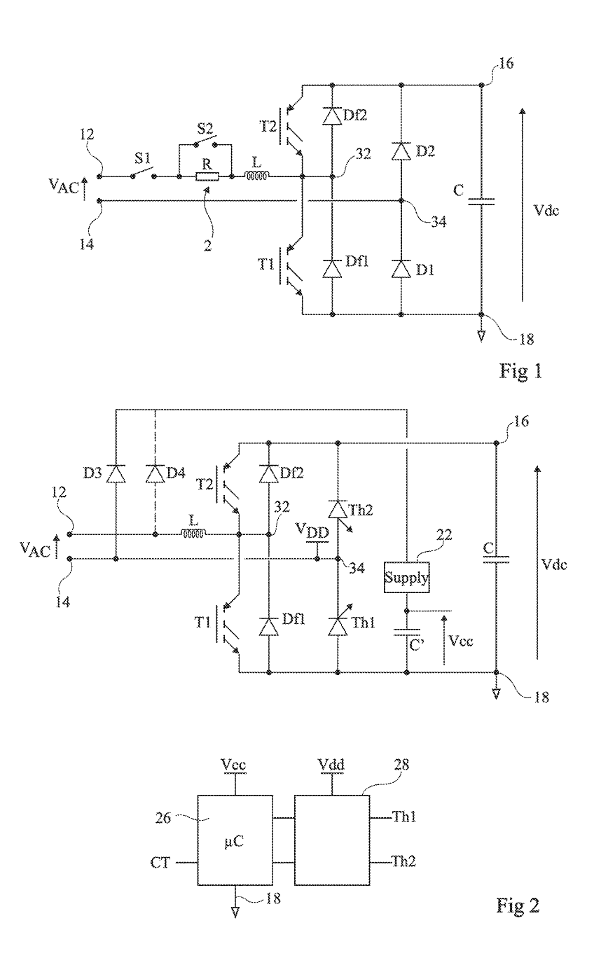

FIG. 1 schematically shows an example of usual architecture of a “totem pole” AC/DC converter equipped with an inrush current limiting circuit.

Two input terminals 12 and 14 are intended to receive an AC voltage Vac, for example, the voltage of the electric distribution network (for example, 230 or 120 volts, 50 or 60 Hz). Terminal 12 is coupled, via an inrush current limiting assembly 2, to a first terminal of an inductive element L, having a second terminal coupled to junction point 32 of two switches T2 and T1 between two terminals 16 and 18, for delivering a DC voltage Vdc, terminal 18 defining a reference potential, typically, the ground. Two diodes Df1 and Df2 are also series-connected between terminals 16 and 18 and have their junction point connected to node 32, the anode of terminal Df1 being connected to terminal 18 while the cathode of diode Df2 is connected to terminal 16. Terminal 14 is connected to junction point 34 of two diodes D1 and D2 between terminals 16 and 18, the anode of diode D1 being connected to terminal 18 while the cathode of diode D2 is connected to terminal 16. A storage and smoothing capacitor C connects terminals 16 and 18. Finally, a turn-on switch S1 is interposed between terminal 12 and circuit 2.

Inrush current limiting circuit 2 is formed of a resistor R coupling (via switch S1) terminal 12 to node 32 to limit the inrush current at the starting of the converter (when capacitor C is discharged). A switch S2 short-circuits resistor R in steady state and thus limits the losses of this resistor when the capacitor is charged.

During positive halfwaves of voltage Vac, switch T2 remains off. Diode D1 drives and couples terminal 18, that is, the reference potential of output voltage Vdc, to terminal 14. Switch T1 is controlled in pulse-width modulation and diode Df2 is used as a free wheel diode during periods when switch T1 is off. During negative halfwaves, switch T1 remains off. Diode D2 drives and couples terminal 14 to terminal 16, that is, to the high potential of output voltage Vdc. Switch T2 is controlled in pulse-width modulation and diode Df1 is used as a free wheel diode during periods when switch T2 is off.

FIG. 2 schematically shows an embodiment of a “totem pole” current limiting AC/DC converter.

As compared with the assembly of FIG. 1, diodes D1 and D2 are replaced with thyristors Th1 and Th2. In the example of FIG. 2, thyristor Th1 has a cathode gate and has its anode connected to terminal 18 while thyristor Th2 has an anode gate and has its cathode connected to terminal 16.

The use of thyristors Th1 and Th2 makes a phase angle control possible, with a turning-on delayed with respect to the zero of rectified voltage Vac, which enables to limit inrush currents at the starting by performing a soft start. The thyristor conduction time is progressively increased to provide a progressive charge of capacitor C. Thus, circuit 2 of FIG. 1 is no longer necessary.

In steady state, thyristors Th1 and Th2 are respectively turned on during positive and negative halfwaves to recover the function of diodes D1 and D2 of FIG. 1.

According to the embodiments, switch S1 for setting the converter to stand-by is kept or not.

In the example of FIG. 2, it is provided to suppress switch S1 and to take advantage of the presence of thyristors Th1 and Th2 to open all the conduction branches during periods during which the converter is set to stand-by.

To keep a power supply allowing a new starting, a circuit 22 (Supply) for generating a DC voltage Vcc across a capacitor C′ is provided to supply an electronic circuit 26, for example, a microcontroller (μC), in charge of generating pulses for controlling thyristors Th1 and Th2. A diode D3 connects one of terminals 12 and 14 to circuit 22 to perform a halfwave rectification. A diode D4 may connect (connection in dotted lines in FIG. 2) the other one of terminals 12 and 14 to circuit 22 for a fullwave rectification.

If switch S1 is kept, its turning-on starts the power supply of circuit 22.

Microcontroller 26 controls the gates of thyristors Th1 and Th2 via one or two insulated couplers 28 in optical, magnetic, or capacitive technology. Microcontroller 26 receives different set points CT or measurements to turn on thyristors Th1 and Th2 at the right times for the fullwave control in steady state.

In the embodiment of FIG. 2, thyristors Th1 and Th2 are selected so that their control is referenced to the same point. Thus, thyristor Th2 is an anode-gate thyristor. Its control is thus referenced to terminal 34. Thyristor Th1 is a cathode-gate thyristor. Its control is thus referenced to the same terminal 34. Thyristors Th2 and Th1 are selected to both operate by gate current extraction. This embodiment enables to control the two thyristors by using a single auxiliary power supply having its positive terminal (Vdd) connected to terminal 34.

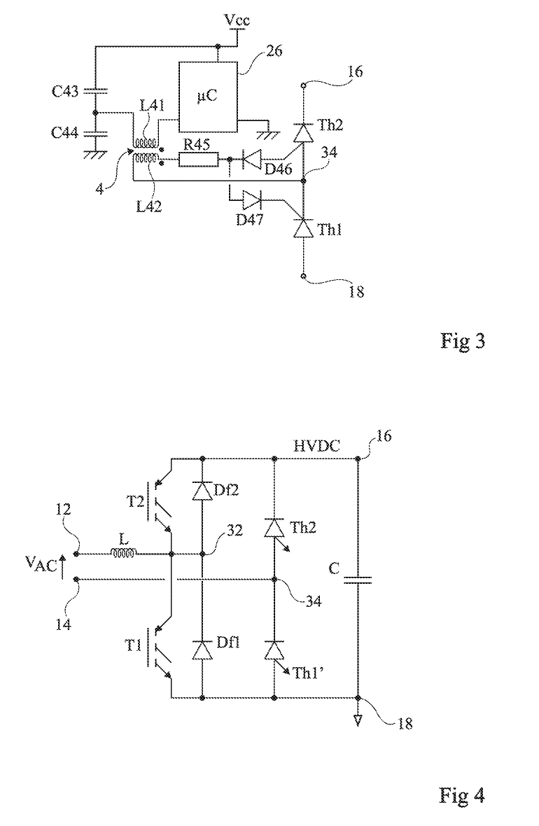

FIG. 3 partially shows another embodiment of a power converter and of its circuit for controlling thyristors Th1 and Th2.

Thyristors Th1 and Th2 are also here selected so that their control is referenced to the same point. Thus, thyristor Th2 is an anode-gate thyristor. Its control is thus referenced to terminal 34. Thyristor Th1 is a cathode-gate thyristor. Its control is thus referenced to the same terminal 34. Thyristors Th2 and Th1 are selected to respectively operate by gate current extraction and by gate current injection.

In the circuit of FIG. 3, a first winding L41 of a transformer 4 receives a pulse control from a microcontroller 26 powered with a DC voltage Vcc (for example, provided by circuit 22 (FIG. 2)). The other end of winding L41 is coupled to the junction point of two capacitive elements C43 and C44 between power supply terminal Vcc and the ground. A second winding L42 of transformer 4 has one end connected to terminal 34 and its other end coupled to the gates of thyristors Th1 and Th2. This coupling is performed via an optional series resistor R45 and two diodes D46 and D47 respectively connecting winding L42 (or resistor R45) to the gates of thyristors Th2 and Th1. The anode gate of thyristor Th2 is coupled to the anode of diode D46 while the cathode gate of thyristor Th1 is coupled to the cathode of diode D47, the cathode of diode D46 and the anode of diode D47 being connected to winding L42 (or to resistor R45).

The circuit of FIG. 3 thus enables to both inject a gate current into thyristor Th1, and to extract a gate current from thyristor Th2. The two thyristors are thus controlled each time an AC pulse (of+Vcc/2−Vcc/2 type) is applied to primary L41 of transformer 4.

To only control thyristor Th2 during positive halfwaves of voltage Vac and only control thyristor Th1 during negative halfwaves of voltage Vac, one applies across inductance L41 respectively during these two types of halfwaves a signal of type −Vcc/0 (to turn on thyristor Th2) and a signal of type +Vcc/0 (to turn on thyristor Th1). Since such signals have a DC component, transformer 4 should not have a saturable magnetic material to avoid the saturation of this material and ensure the proper operation of the control signal transfer. A transformer with no magnetic core (or “air transformer”) may thus for example be used.

FIG. 4 partially shows another embodiment where thyristors Th1′ and Th2 are both anode-gate thyristors. Thyristor Th1′ may be directly controlled by an output of the microcontroller (26, FIG. 2). Thyristor Th2 is controlled from voltage Vac or from a DC voltage HVDC as soon as thyristor Th2 is conductive.

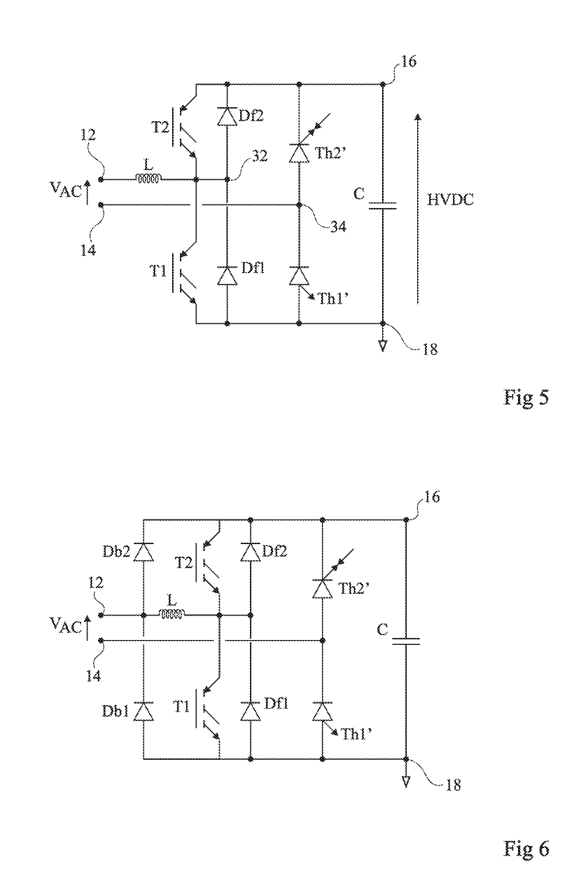

FIG. 5 partially shows still another embodiment where thyristors Th1′ and Th2′ respectively have an anode gate and a cathode gate, where thyristor Th2′ can be controlled by gate current injection and extraction, that is, both by a positive gate current and by a negative gate current. Thyristor Th1′ may be directly controlled by an output of the microcontroller (26, FIG. 2). Thyristor Th2′ may also be controlled from the microcontroller when the capacitor is not or only lightly charged and from a DC voltage referenced to the high potential of the power supply voltage, for example, voltage HVDC present between terminals 16 and 18.

FIG. 6 partially shows still another embodiment where diodes Db1 and Db2 directly couple, respectively, terminal 18 to terminal 12 and terminal 12 to terminal 16. The function of these diodes is to short-circuit (and to protect) respectively diodes Df1 and Df2 in case of an overcurrent originating from an overvoltage of voltage Vac. Diodes Db1 and Db2 may be replaced with cathode-gate thyristors, respectively controlled at the same time as thyristors Th1′ and Th2′. These additional thyristors may as a variation be controlled by Zener diodes coupling, in series with a diode of opposite biasing, their respective gate to terminal 12 or to terminal 18.

The achieving of a function of cathode-gate thyristor controllable by current extraction is known. A triac series-connected with a diode to be made unidirectional may for example be used.

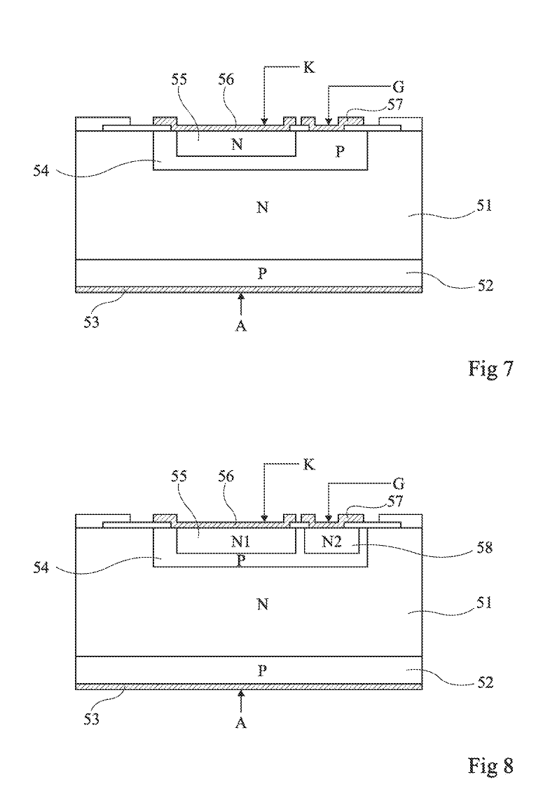

FIGS. 7 and 8 are simplified cross-section views of embodiments of cathode-gate thyristors respectively with a positive gate current or current injection (most current case) and with a negative gate current or current extraction.

According to these examples, the thyristor is formed in an N-type substrate 51. At the rear surface, a P-type layer 52 defines an anode region, anode electrode A being obtained by a contacting metallization 53 of region 52. A P-type well 54 is formed at the front surface. An N-type cathode region 55 (N1) is formed in well 54 and a contacting metallization 56 of this region 55 defines cathode electrode K.

In the case of FIG. 7, a gate contact 57 is formed at the level of P-type well 54. Thus, the injection of a gate current starts the thyristor if the latter is properly biased (positive anode-cathode voltage).

In the case of FIG. 8, an N-type region 58 (N2) is added under gate contact 57. Region 58 allows a turning-on by a negative gate current (that is, flowing from cathode K to gate G) by allowing an electron injection into N-type substrate 51, which corresponds to the base of the NPN-type bipolar transistor formed by regions 52-51-54.

The forming of the anode-gate thyristors can be deduced from the above examples of FIGS. 7 and 8.

As a variation, region 58 may be divided at least in two to allow a direct contact of the P region (54) with the gate. Such a variation, called “short-circuit hole”, enables to improve the immunity to voltage transients of the thyristor and also allows a control by a positive gate current (that is, flowing from gate G to cathode K). Such a variation thus enables the thyristor to be used at the level of component Th2′ in the circuit of FIG. 5.

An advantage of the embodiments which have been described is to keep the high efficiency of a “totem pole” architecture while suppressing the inrush current limiting resistance.

Similarly, the described solutions preserve a low common-mode noise, the terminal at the reference potential (generally, the ground bus) being switched at the frequency of the AC power supply and not at that of the pulses for controlling switches T1 and T2.

Further, for the case where triac-type components are present on the AC voltages side, their thyristors may be powered with voltage Vdd, called “negative”, used to control the triacs.

The described embodiments are compatible with usual structures selected for components T1, T2, Df1, and Df2 in a “totem pole” architecture. For example, switches T1 and T2 are power transistors. According to another example, diodes Df1 and Df2 are formed of the intrinsic diodes of MOSFET transistors made of silicon, silicon carbide, or another technology.

Various embodiments have been described. Various alterations, modifications, and improvements will occur to those skilled in the art. For example, the thyristors may be replaced with triacs, each series-connected with a diode.

Further, any alternative cathode-gate or anode-gate thyristor controlled by gate current injection or extraction may be used instead of thyristors Th, Th2, Th1′, and Th2′. For example, the circuit of FIG. 5 could use a cathode-gate thyristor controlled by current injection only, as soon as an insulated coupled is used to control thyristor Th2′.

Further, the practical implementation of the embodiments which have been described is within the abilities of those skilled in the art based on the functional indications given hereabove. In particular, the programming of the microcontroller depends on the application and the described embodiments are compatible with usual applications using a microcontroller or the like to control a converter.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. An AC/DC converter, comprising:
a first terminal and a second terminal configured to receive an AC voltage;
a third terminal and a fourth terminal configured to supply a DC voltage;
first and second switches in series-connection between the third and fourth terminals and having a junction point connected to the first terminal; and
first and second controllable rectifying elements in series-connection between the third and fourth terminals and having a junction point connected to one of the first terminal or the second terminal.

2. The converter of claim 1, further comprising first and second diodes respectively connected in parallel with the first and second switches.

3. The converter of claim 2, wherein said first and second diodes are formed by the intrinsic diodes of the first and second switches.

4. The converter of claim 1, wherein the first and second controllable rectifying elements are phase-angle controlled.

5. The converter of claim 1, wherein the first and second controllable rectifying elements are, respectively, a cathode-gate thyristor and an anode-gate thyristor, the anode-gate thyristor being controllable by extraction of a current from its gate.

6. The converter of claim 5, wherein the anode-gate thyristor is connected to the third terminal.

7. The converter of claim 6, wherein the cathode-gate and anode-gate thyristors are controlled by a same pulse signal.

8. The converter of claim 5, wherein the anode-gate thyristor is connected to the fourth terminal, the cathode-gate thyristor is connected to the third terminal, and the cathode-gate thyristor is controllable by one of injection or extraction of a gate current.

9. The converter of claim 1, wherein the first and second controllable rectifying elements are anode-gate thyristors controlled by extraction of a gate current.

10. The converter of claim 1, further comprising:
a power supply circuit configured for powering a control circuit of at least the first and second controllable rectifying elements; and
at least one diode coupling one of the first and second terminals to said power supply circuit.

11. An AC/DC converter, comprising:
a first terminal and a second terminal configured to receive an AC voltage;
a third terminal and a fourth terminal configured to supply a DC voltage;
a first transistor switch connected between the first terminal and the third terminal;
a second transistor switch connected between the first terminal and the fourth terminal;
an anode-gate thyristor connected between the second terminal and the third terminal;
a cathode-gate thyristor connected between the second terminal and the fourth terminal;
a control circuit configured to apply control signals for controlling the anode-gate and cathode-gate thyristors.

12. The converter of claim 11, wherein the control circuit comprises a first diode controlled to extract current from a gate of the anode-gate thyristor and a second diode controlled to apply current to a gate of the cathode-gate thyristor.

13. The converter of claim 11, wherein the anode-gate thyristor and cathode-gate thyristor are phase-angle controlled by said control circuit.

14. An AC/DC converter, comprising:
a first terminal and a second terminal configured to receive an AC voltage;
a third terminal and a fourth terminal configured to supply a DC voltage;
a first transistor switch connected between the first terminal and the third terminal;
a second transistor switch connected between the first terminal and the fourth terminal;
a first anode-gate thyristor connected between the second terminal and the third terminal;
a second anode-gate thyristor connected between the second terminal and the fourth terminal;
a control circuit configured to apply control signals for controlling the first and second anode-gate thyristors.

15. The converter of claim 14, wherein the anode-gate thyristor and cathode-gate thyristor are phase-angle controlled by said control circuit.
